(19) United States
(12) Patent Application Publication
(10) Pub. No.: US 2025/0023268 A1
(43) Pub. Date: Jan. 16, 2025

(54) GROUND BUS FOR A CABLE CARD ASSEMBLY OF AN ELECTRICAL CONNECTOR

(71) Applicant: TE Connectivity Solutions GmbH, Schaffhausen (CH)

(72) Inventors: Craig Warren Hornung, Harrisburg, PA (US); Chad William Morgan, Carneys Point, NJ (US); John Joseph Consoli, Harrisburg, PA (US)

(21) Appl. No.: 18/352,143

(22) Filed: Jul. 13, 2023

(51) Int. Cl. H01R 12/75; H01R 13/652; H01R 13/6581

(52) U.S. Cl. CPC H01R 12/75; H01R 13/652; H01R 13/6581

(57) ABSTRACT

A cable card assembly for an electrical connector includes a circuit card having circuit conductors on a surface of the circuit card and a ground plane. The cable card assembly includes cables terminated to the circuit card. The cables include signal conductors electrically connected to corresponding circuit conductors of the circuit card and cable shields providing electrical shielding for the signal conductors. The cable card assembly includes a ground bus coupled to the circuit card and electrically connected to the cable shields and the ground plane. The ground bus includes a shell forming pockets receiving the corresponding cables. The shell has an inner bus member mounted to the circuit card and an outer bus member coupled to the inner bus member. The shell includes a conductive gasket between the inner bus member and the outer bus member.

### BACKGROUND OF THE INVENTION

The subject matter herein relates generally to electrical connectors.

Electrical connectors are typically used to electrically couple various types of electrical devices to transmit signals between the devices. At least some known cable assemblies have cables between electrical connectors, which are coupled to corresponding electrical devices. The cables each have a signal conductor, or a differential pair of signal conductors surrounded by a shield layer that, in turn, is surrounded by a cable jacket. The shield layer includes a conductive foil, which functions to shield the signal conductor(s) from electromagnetic interference (EMI) and generally improve performance. A drain wire may be provided within the cable, electrically connected to the conductive foil. At an end of the communication cable, the cable jacket, the shield layer, and insulation that covers the signal conductor(s) may be removed (e.g., stripped) to expose the signal conductor(s) and the drain wire. The exposed portions of the signal conductor(s) are then mechanically and electrically coupled (e.g., soldered) to corresponding conductors, such as signal pads of a circuit card. The exposed portions are bent and manipulated between the insulator and the signal pads on the circuit card.

However, signal integrity and electrical performance of the electrical connectors are negatively impacted at the interface between the cables and the circuit card. For example, as the signal conductors transition to the circuit card, the cable shield no longer shields the exposed portions of the signal conductors, which affects signal integrity and detrimentally affects performance. Shields may be provided to cover the ends of the cables. However, shielding effectiveness may be poor based on the shape of the shield and gaps or openings in the shield.

Accordingly, there is a need for an electrical connector having an improved shielded interface with a circuit card.

### BRIEF DESCRIPTION OF THE INVENTION

In one embodiment, a cable card assembly for an electrical connector is provided and includes a circuit card having an array of circuit conductors on a surface of the circuit card. The circuit card has a ground plane. The cable card assembly includes cables terminated to the circuit card. The cables include signal conductors and cable shields surrounding the corresponding signal conductors to provide electrical shielding for the signal conductors. The signal conductors are electrically connected to corresponding circuit conductors of the circuit card. The cable card assembly includes a ground bus coupled to the circuit card. The ground bus is electrically connected to the cable shields of the cables. The ground bus is electrically connected to the ground plane of the circuit card. The ground bus includes a shell forming pockets receiving the corresponding cables. The shell has an inner bus member and an outer bus member coupled to the inner bus member. The inner bus member is mounted to the circuit card. The shell includes a conductive gasket between the inner bus member and the outer bus member.

In another embodiment, a ground bus for electrically connecting cables to a circuit card of a cable card assembly is provided. The ground bus includes a shell including an inner bus member and an outer bus member separate and discrete from the inner bus member and coupled to the inner bus member at an interface. The inner bus member includes a bottom configured to be mounted to the circuit card. The inner bus member includes inner pockets. The inner bus member is configured to be positioned between the cables and the circuit card. The outer bus member includes covers configured to cover the cables. The covers form outer pockets cooperating with the inner pockets to receive the corresponding cables. The inner bus member is electrically conductive and provides shielding around portions of the cables. The outer bus member is electrically conductive and provides shielding around portions of the cables. The ground bus includes a conductive gasket between the inner bus member and the outer bus member. The conductive gasket is electrically connected to the inner bus member and is electrically connected to the outer bus member to provide shielding at the interface.

In a further embodiment, an electrical connector is provided and includes a housing that has walls forming a cavity. The housing has a mating end configured to be mated with a second electrical connector. The electrical connector includes a cable card assembly received in the cavity of the housing. The cable card assembly includes a circuit card, cables terminated to the circuit card, and a ground bus coupled to the circuit card to provide shielding for the cables. The circuit card has an array of circuit conductors on a surface of the circuit card. The circuit card has a ground plane. The cables include signal conductors and cable shields surrounding the corresponding signal conductors to provide electrical shielding for the signal conductors. The signal conductors are electrically connected to corresponding circuit conductors of the circuit card. The ground bus is electrically connected to the cable shields of the cables. The ground bus is electrically connected to the ground plane of the circuit card. The ground bus includes a shell forming pockets receiving the corresponding cables. The shell has an inner bus member and an outer bus member coupled to the inner bus member. The shell includes a conductive gasket between the inner bus member and the outer bus member.

### BRIEF DESCRIPTION OF THE DRAWINGS

FIG. 1 is a perspective view of a communication system in accordance with an exemplary embodiment.

FIG. 2 is a perspective view of the second electrical connector in accordance with an exemplary embodiment.

FIG. 3 is a perspective view of the first electrical connector in accordance with an exemplary embodiment.

FIG. 4 is a perspective view of the cable card assembly in accordance with an exemplary embodiment.

FIG. 5 is a top perspective view of a portion of the cable card assembly in accordance with an exemplary embodiment showing a portion of the ground bus and a subset of the cables.

FIG. 6 is a bottom perspective view of a portion of the ground bus showing the outer bus member in accordance with an exemplary embodiment.

FIG. 7 is a top perspective view of a portion of the cable card assembly in accordance with an exemplary embodiment showing a portion of the ground bus and subsets of the cables.

FIG. 8 is a top perspective view of a portion of the cable card assembly in accordance with an exemplary embodiment showing a portion of the ground bus and subsets of the cables.

FIG. 9 is a top perspective view of a portion of the cable card assembly in accordance with an exemplary embodiment.

### DETAILED DESCRIPTION OF THE INVENTION

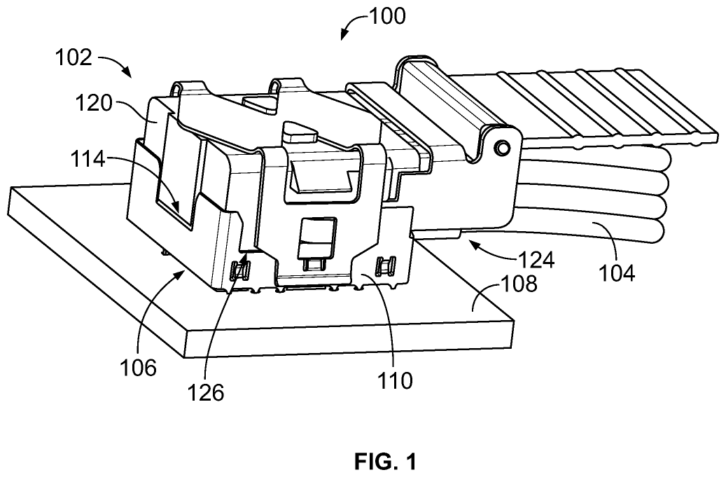

FIG. 1 is a perspective view of a communication system 100 in accordance with an exemplary embodiment. The communication system 100 includes a first electrical connector 102 provided at ends of cables 104 and a second electrical connector 106. In the illustrated embodiment, the second electrical connector 106 is mounted to a circuit board 108. In other various embodiments, the second electrical connector 106 may be provided at ends of cables (not shown).

In an exemplary embodiment, the second electrical connector 106 is a receptacle connector. The second electrical connector 106 may be a socket connector, such as a header connector. In other embodiments, the second electrical connector 106 may be a card edge connector having a card slot. The first electrical connector 102 is mated to the second electrical connector 106 at a separable interface. In an exemplary embodiment, the first electrical connector 102 is a plug connector configured to be pluggably coupled to the second electrical connector 106. For example, a portion of the first electrical connector 102 may be plugged into a receptacle or opening of the second electrical connector 106. In an exemplary embodiment, the first electrical connector 102 is coupled to the second electrical connector 106 at a separable interface. For example, the first electrical connector 102 is latchably coupled to the second electrical connector 106 using a clip or latching elements. The latch may be releasable to allow removal of the first electrical connector 102 from the second electrical connector 106. The connectors 102, 106 may be input-output (I/O) connectors.

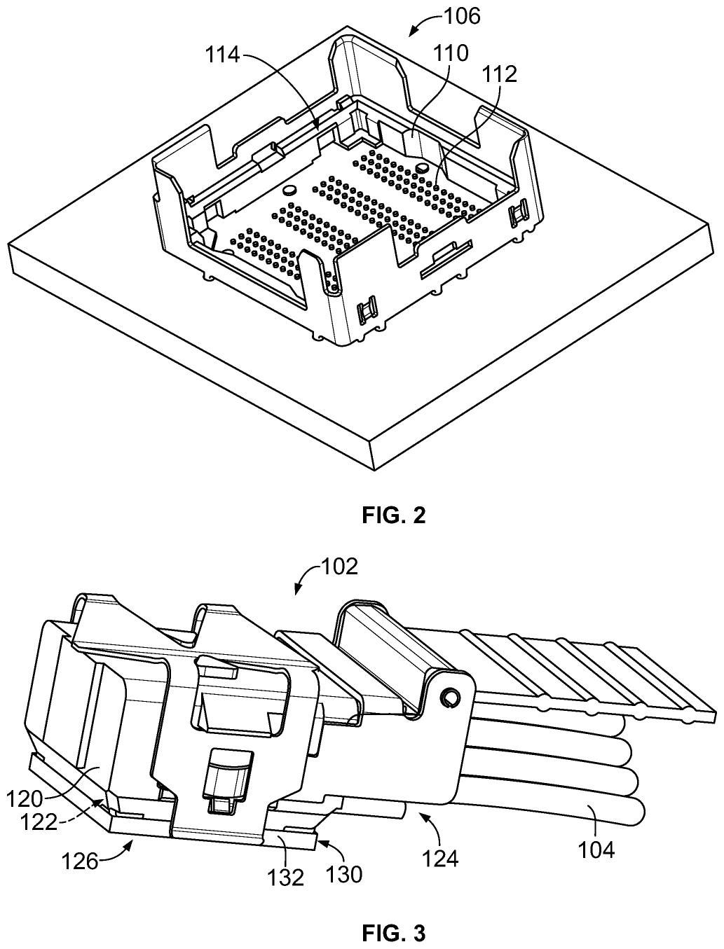

With additional reference to FIG. 2, which is a perspective view of the second electrical connector 106, the second electrical connector 106 includes a receptacle housing 110 holding an array of contacts 112. In an exemplary embodiment, the receptacle housing 110 includes an opening 114 that receives the first electrical connector 102. The opening 114 may be a socket configured to receive the plug end of the first electrical connector 102. The opening 114 may be a card slot in alternative embodiments. The opening 114 is located at the top of the receptacle housing 110 in the illustrated embodiment. Other locations are possible in alternative embodiments, such as at the front. The contacts 112 have separable mating interfaces. The contacts 112 may define a compressible interface, such as including deflectable spring beams that are compressed when the first electrical connector 102 is received in the opening 114. Optionally, the contacts 112 may be arranged in multiple rows and columns. In various embodiments, the contacts 112 are a land grid array (LGA). In various embodiments, the second electrical connector 106 is a communication device, such as a socket connector. The second electrical connector 106 may be a high-speed connector.

With additional reference to FIG. 3, which is a perspective view of the first electrical connector 102, the first electrical connector 102 includes a housing 120 having a cavity 122 that receives a cable card assembly 130. The housing 120 has a cable end 124 and a mating end 126 opposite the cable end 124. The cables 104 extend from the cable end 124. The mating end 126 is configured to be coupled to the second electrical connector 106. In the illustrated embodiment, the first electrical connector 102 is a right angle connector. For example, the cable end 124 is at the rear of the housing 120 and the mating end 126 is at the bottom of the housing 120. Other locations are possible in alternative embodiments, such as having the mating end 126 at the front or having the cable end 124 at the top. The cable card assembly 130 includes a circuit card 132. The cables 104 are configured to be terminated to the circuit card 132. The circuit card 132 is configured to be plugged into the opening 114 of the second electrical connector 106 when the first electrical connector 102 is mated with the second electrical connector 106.

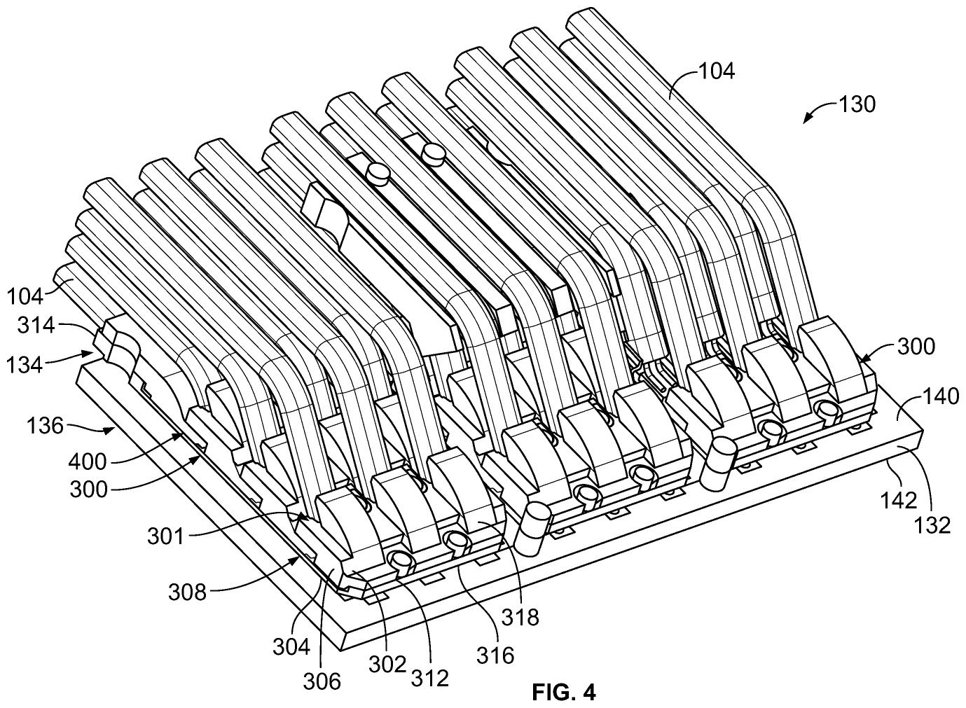

FIG. 4 is a perspective view of the cable card assembly 130 in accordance with an exemplary embodiment. The cable card assembly 130 includes the circuit card 132, the cables 104 connected to the circuit card 132, and a ground bus 300 separate and discrete from the circuit card 132 and coupled to the circuit card 132. The ground bus 300 provides shielding for the ends of the cables 104 and the interface between the cables 104 and the circuit card 132. Optionally, the signal conductors of the cables 104 may be terminated directly to the circuit card 132. Alternatively, a contact assembly (for example, stamped and formed contacts and/or overmolded leadframe(s)) may be provided to electrically connect the signal conductors of the cables 104 to the circuit card 132. The ground bus 300 is electrically coupled to the cables 104, such as cables shields and/or drain wires of the cables 104. The ground bus 300 is electrically coupled to the circuit card 132. For example, the ground bus 300 is electrically connected to circuits or conductors of the circuit card 132, such as to a ground plane of the circuit card 132.

The ground bus 300 provides electrical shielding for the signal conductors of the cables 104 and the circuit conductors of the circuit card 132. The ground bus 300 is electrically connected to the shield structures of the cables 104, such as to cable shields of the cables 104 and/or drain wires of the cables 104. In an exemplary embodiment, the ground bus 300 is connected to the cable shields and/or the drain wires using a conductive gasket, conductive adhesive, conductive epoxy, a conductive tape or braid, conductive foam, soldering, and the like. The ground bus 300 may be soldered to the circuit card 132. However, the ground bus 300 may be connected to the circuit card 132 at a solderless connection, such as at an interference or press-fit connection. In various embodiments, multiple ground busses 300 may be provided.

In an exemplary embodiment, the cable card assembly 130 includes multiple rows and columns of cables 104. The cables 104 may be grouped together, such as in 3×4 arrangements. The cables 104 are terminated to one side of the circuit card 132, such as the top side of the circuit card 132. However, the cables 104 may additionally or alternatively be terminated to the bottom side of the circuit card 132. Each row of cables 104 includes the corresponding ground bus 300. The ground busses 300 may be similar for each of the rows. However, the ground busses 300 may be sized and shaped differently to accommodate a stacking/overlapping situation.

The circuit card 132 extends between a cable end 134 (for example, top portion) and a mating end 136 (for example, bottom portion). Other arrangements are possible in alternative embodiments, such as having the mating end 136 at a front edge of the circuit card 132 to plug into a card slot. The cable end 134 may be provided at the bottom portion in other alternative embodiments. The cables 104 are configured to be coupled to the circuit card 132 at the cable end 134. The cables 104 extend rearward from the circuit card 132 in the illustrated embodiment. The circuit card 132 includes an upper surface 140 and a lower surface 142. The cables 104 are connected to the circuit card 132 at the upper surface 140 in the illustrated embodiment. The lower surface 142 may be mated to the second electrical connector 106 in the illustrated embodiment.

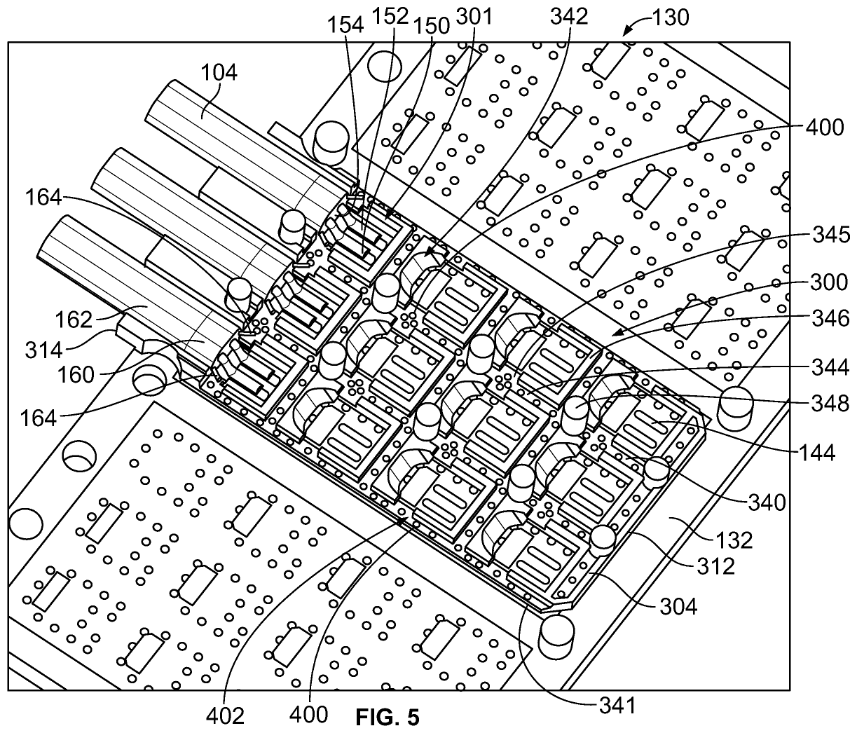

The circuit card 132 includes circuit conductors 144 (shown in FIG. 5), such as mating pads, traces, vias, and the like. The circuit conductors 144 may be provided at both the upper surface 140 and the lower surface 142. The circuit conductors 144 may include both signal conductors and ground conductors of the circuit card 132. In an exemplary embodiment, the circuit conductors 144 are provided at the cable end 134 for connection to the cables 104 (and/or the contact assembly) and at the mating end 136 for connection to the second electrical connector 106. The circuit conductors 144 at the mating end 136 define mating conductors configured to be electrically connected to corresponding contacts 112 (shown in FIG. 2) of the second electrical connector 106. The circuit conductors 144 at the cable end 134 are configured to be electrically connected to the signal conductors of the cables 104 and the ground bus 300.

The ground bus 300 surrounds the ends of the cables 104. For example, the ends of the cables 104 are located in corresponding pockets 301 in the ground bus 300. The ground bus 300 is electrically connected to the cables 104 (for example, the cable shield and/or drain wires). The ground bus 300 is terminated to the circuit card 132. The ground bus 300 electrically commons the cables 104 with the circuit card 132. The ground bus 300 electrically commons the cables 104 with each other. The ground bus 300 provides electrical shielding for signals transmitted between the circuit card 132 and the cables 104. The ground bus 300 enhances electrical performance of the cable card assembly 130, such as by reducing cross talk.

The ground bus 300 includes a shell 302 manufactured from a conductive material, such as a metal material to provide electrical shielding. In various embodiments, the ground bus 300 may be a diecast component. In other various embodiments, the ground bus 300 may be a stamped and formed component. In an exemplary embodiment, the ground bus 300 is a multipiece structure. For example, the ground bus 300 includes one or more inner bus members 304, one or more outer bus members 306, and one or more conductive gaskets 400 at the interface(s) 308 between the inner bus member(s) 304 and the outer bus member(s) 306. The conductive gaskets 400 provide shielding at the interface 308. The conductive gaskets 400 electrically connect the inner and outer bus members 304, 306. The conductive gaskets 400 may additionally mechanically connect the inner and outer bus members 304, 306. The inner bus member 304 is located between the outer bus members 306 and the circuit card 132. The ground bus 300 may be oriented such that the inner bus member 304 is a bottom bus member and the outer bus member 306 is a top bus member. However, other orientations are possible in alternative embodiments. The cables 104 are received between the inner bus member 304 and the outer bus member 306. For example, the pockets 301 may be formed by the inner and outer bus members 304, 306 and the cables 104 are received in the pockets 301 between the inner and outer bus members 304, 306. The conductive gaskets 400 may be located in the pockets 301 to electrically connect to the cables 104.

The ground bus 300 extends between a front 312 and a rear 314. The rear 314 is configured to face the cables 104. The ground bus 300 extends between an inner end 316 and an outer end 318. The inner bus member 304 is at the inner end 316 and the outer bus member 306 is at the outer end 318. The cables 104 may extend form the outer end 318, such as toward the rear 314. The ground bus 300 may be oriented such that the inner end 316 is a bottom end and the outer end 318 is a top end. However, other orientations are possible in alternative embodiments. In various embodiments, the inner end 316 is at the bottom and is configured to face the circuit card 132. The inner end 316 may be mounted to the circuit card 132 to mechanically and electrically connect the ground bus 300 to the circuit card 132. The inner end 316 may be soldered to the circuit card 132.

FIG. 5 is a top perspective view of a portion of the cable card assembly 130 in accordance with an exemplary embodiment showing a portion of the ground bus 300 and a subset of the cables 104. Each cable 104 includes at least one signal conductor and a shield structure providing electrical shielding for the at least one signal conductor. In an exemplary embodiment, the cables 104 are twin-axial cables. For example, each cable 104 includes a first signal conductor 150 and a second signal conductor 152. The signal conductors 150, 152 carry differential signals. The signal conductors 150, 152 are configured to be electrically connected to corresponding circuit conductors 144 of the circuit card 132. However, the cables 104 may include greater or fewer signal conductors in alternative embodiments, such as being a coaxial cable.

The cable 104 includes one or more insulators 154 surrounding the signal conductors 150, 152 and a cable shield 160 surrounding the insulators 154. The cable shield 160 provides circumferential shielding around the signal conductors 150, 152. The cable 104 includes a cable jacket 162 surrounding the cable shield 160. In various embodiments, the cable 104 includes one or more drain wires 164 electrically connected to the cable shield 160. In alternative embodiments, the cable 104 is provided without a drain wire.

In an exemplary embodiment, the cable jacket 162, the cable shield 160, and the insulators 154 may be removed (e.g., stripped) to expose portions of the signal conductors 150, 152 for termination to the circuit card 132 (or to the contact assembly). A portion of the cable shield 160 may be exposed and/or portions of the drain wires 164 may be exposed for termination to the ground bus 300. The exposed portions of the signal conductors 150, 152 are configured to be mechanically and electrically coupled (e.g., soldered) to corresponding circuit conductors 144 of the circuit card 132. The cable shield 160 does not extend along the exposed portions. However, the ground bus 300 extends along the exposed portions and provides shielding for the exposed portions. The ground bus 300 may be shaped and positioned relative to the exposed portions to control impedance along the signal paths. For example, the ground bus 300 may be shaped and positioned relative to the exposed portions to maintain a target impedance along the signal paths (for example, 50 Ohms, 75 Ohms, 100 Ohms, and the like).

The inner bus member 304 of the ground bus 300 is shown in FIG. 5. The inner bus member 304 is configured to provide shielding for the cables 104. For example, the inner bus member 304 forms portions of the pockets 301 that receive the corresponding cables 104. Optionally, each pocket 301 may receive a single (for example, different) cable 104. The inner bus member 304 extends between the front 312 and the rear 314. The inner bus member 304 is manufactured from a conductive material, such as a metal material. In various embodiments, the inner bus member 304 is a diecast member. In other various embodiments, the inner bus member 304 may be a plated plastic member. In the illustrated embodiment, the inner bus member 304 is shown as a single unit between the front 312 and the rear 314 configured to accommodate multiple rows of the cables 104. However, in alternative embodiments, the inner bus member 304 may be a multi-piece structure, such as including a stack of bus elements arranged front to rear to accommodate corresponding rows of the cables 104.

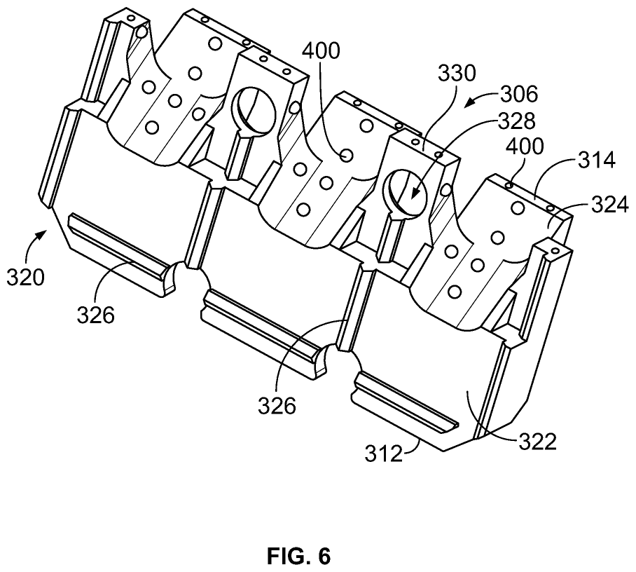

The inner bus member 304 includes a base 340 having a bottom 341 configured to be mounted to the circuit card 132. The base 340 includes cable cradles 342 configured to receive corresponding cables 104. The cable cradles 342 form portions of the pockets 301. The cable cradles 342 support the cables 104 for termination to the circuit card 132. The base 340 includes separating walls 344 between the pockets 301. The separating walls 344 surround the pockets 301. For example, the separating walls 344 extend along both sides of the pockets 301, extend along the fronts of the pockets 301 and extend along the rears of the pockets 301. The separating walls 344 provide shielding between the pockets 301. Each separating wall 344 includes an upper surface 345. The outer bus members 306 (FIG. 6) are configured to be coupled to the inner bus member 304 at the upper surface 345. The conductive gaskets 400 are provided at the upper surface 345.

In an exemplary embodiment, the inner bus member 304 includes locating elements 346 extending along the separating walls 344. The locating elements 346 are used for positioning and/or shielding between the outer bus members 306. The locating elements 346 are located between the pockets 301. The locating elements 346 may be protrusions, such as lips or walls extending from the separating walls 344. In alternative embodiments, the locating elements 346 may be grooves or slots formed in the separating walls 344. Other types of locating elements may be used in alternative embodiments. The locating elements 346 are sized and shaped to interact with complimentary elements of the outer bus members 306.

In an exemplary embodiment, the inner bus member 304 includes locating pins 348 extending from the separating walls 344. The locating pins 348 may extend upward from the upper surfaces 345 of the separating walls 344. The locating pins 348 are configured to interface with the outer bus members 306 to locate the outer bus members 306 relative to the inner bus member 304. For example, the locating pins 348 may be received in the openings in the outer bus members 306 to align the outer bus members 306 with the inner bus member 304. The locating pins 348 may be press-fit into the outer bus members 306 to mechanically and electrically connect the outer bus member 306 to the inner bus member 304.

In an exemplary embodiment, the conductive gasket 400 is provided on the inner bus member 304. The conductive gasket 400 is located at the interface between the inner bus member 304 and the outer bus member 306 (FIG. 6) to provide shielding at the interface. For example, the conductive gasket 400 is applied to the upper surface 345 of the separating walls 344. The conductive gasket 400 may additionally or alternatively be applied to the locating elements 346. The conductive gasket 400 extends around each pocket 301 to provide circumferential shielding around each pocket 301. For example, the conductive gasket 400 may be applied on all four sides of each pocket 301 (for example, front, rear, right and left).

In an exemplary embodiment, the conductive gasket 400 is formed in place on the inner bus member 304. For example, the conductive gasket 400 may be dispensed by a dispensing tool at precise locations. In various embodiments, the conductive gasket 400 is applied in a dispersed pattern across the interface. For example, the conductive gasket 400 may be discontinuous with spaces or gaps 402 between the conductive gasket 400 deposits, such as to reduce the amount of material used to reduce cost. The gaps 402 are sized for shielding (for example, to prevent EMI leakage) at certain frequencies. In various embodiments, the gaps 402 are less than 1.0 mm. Optionally, the conductive gasket 400 may be applied in dots or lines.

In various embodiments, the conductive gasket 400 is a room temperature vulcanization (RTV) material. For example, the material may be a silicon material, such as silicone rubber having conductive fillers such that the material is electrically conductive. In an exemplary embodiment, the material is non-flowable or is a limited flow material to avoid leaking into unwanted areas of the ground bus 300, such as into the pockets 301. In an exemplary embodiment, the conductive gasket 400 sets or cures readily, such as at room temperature. For example, the conductive gasket 400 may set or cure without additional input, such as without additional heat. In an exemplary embodiment, the conductive gasket 400 is fixed to the inner bus member 304 at a temperature lower than a solder temperature to avoid damaging the cable.

In an exemplary embodiment, the conductive gasket 400 is electrically connected to the drain wires 164. For example, the conductive gasket 400 is applied at the corner of the pocket 301. The drain wires 164 are routed to the corner to interface with the conductive gasket 400.

FIG. 6 is a bottom perspective view of a portion of the ground bus 300 showing the outer bus member 306 in accordance with an exemplary embodiment. The outer bus member 306 extends between the front 312 and the rear 314. The outer bus member 306 is manufactured from a conductive material, such as a metal material. In various embodiments, the outer bus member 306 is a diecast member. In other various embodiments, the outer bus member 306 may be stamped and formed or a plated plastic member. The outer bus member 306 is configured to provide shielding for the cables 104 (shown in FIG. 15).

The outer bus member 306 includes a cap 320 having a base wall 322 and cable covers 324. The cable covers 324 may be angled to accommodate the cables 104 extending outward from the circuit card 132, such as at an angle between 30° and 60°. The base wall 322 is provided at the bottom or inner end of the outer bus member 306. The base wall 322 is configured to be coupled to the inner bus member 304 (shown in FIG. 5).

In an exemplary embodiment, the outer bus member 306 includes locating elements 326 extending from the base wall 322 of the cap 320. The locating elements 326 are used for positioning and/or shielding between the outer bus member 306 and the inner bus member 304. The locating elements 326 may interact with the locating elements 346 of the inner bus member 304 to locate the outer bus member 306 relative to the inner bus member 304. The locating elements 346 cause the base wall 322 to be non-planar, which improves EMI shielding at the interface.

In an exemplary embodiment, the cap 320 includes openings 328 in the base wall 322. The openings 328 receive the locating pins 348 (FIG. 5) to locate the outer bus member 306 relative to the inner bus member 304.

In an exemplary embodiment, the conductive gasket 400 is provided on the outer bus member 306. For example, the conductive gasket 400 is provided on the base wall 322 and/or the cable cover 324. The conductive gasket 400 is applied to the base wall 322 to interface with the inner bus member 304. The conductive gasket 400 is applied to the cable cover 324 to interface with the cable 104, such as the cable shield. The conductive gasket 400 may additionally or alternatively be applied to the locating elements 326. The conductive gasket 400 may be applied to edges 330 of the cap 320 to interface with the adjacent outer bus member 306. In an exemplary embodiment, the conductive gasket 400 is formed in place on the outer bus member 306. For example, the conductive gasket 400 may be dispensed by a dispensing tool at precise locations. In various embodiments, the conductive gasket 400 is applied in a dispersed pattern across the interface. For example, the conductive gasket 400 may be discontinuous with spaces or gaps between the conductive gasket 400 deposits.

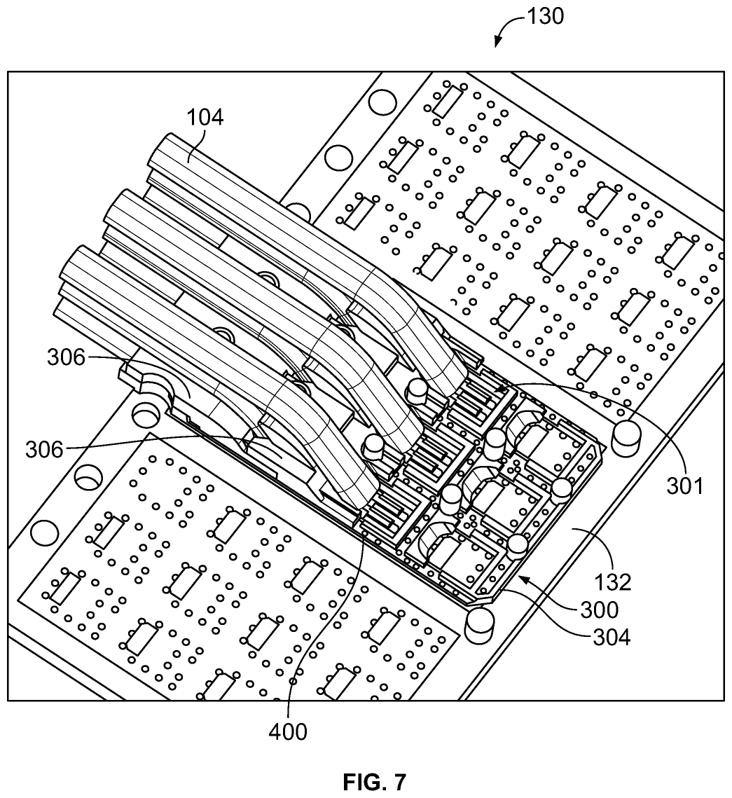

FIG. 7 is a top perspective view of a portion of the cable card assembly 130 in accordance with an exemplary embodiment showing a portion of the ground bus 300 and subsets of the cables 104. FIG. 7 shows the inner bus member 304 connected to the circuit card 132. FIG. 7 illustrates three rows of the cables 104 connected to the circuit card 132, with one row of the pockets 301 open to receive corresponding cables 104 at a later assembly step. FIG. 7 shows two of the outer bus members 306 connected to the inner bus member 304 and deposits of the conductive gasket 400 arranged relative to the pockets 301 to receive the next outer bus member 306 to cover the third row of the cables 104.

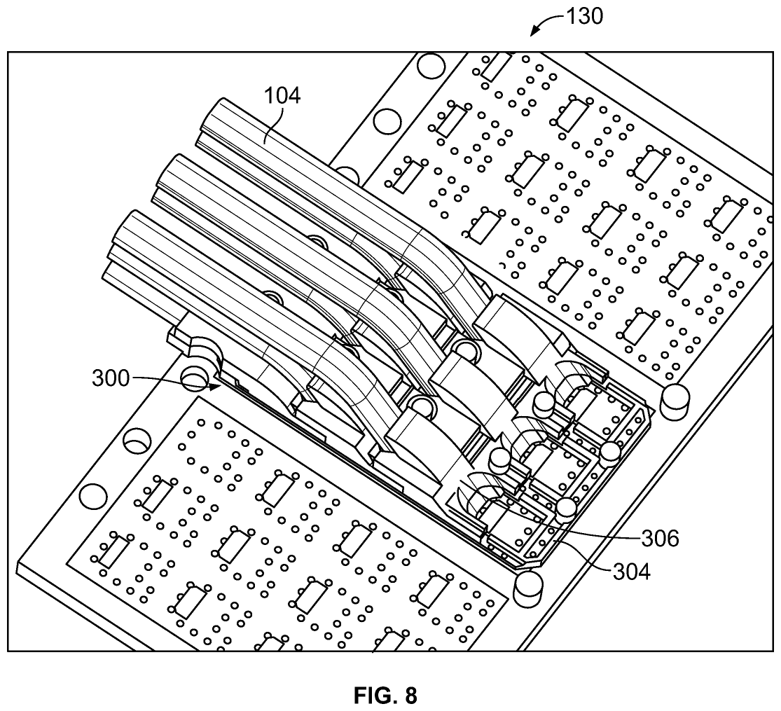

FIG. 8 is a top perspective view of a portion of the cable card assembly 130 in accordance with an exemplary embodiment showing a portion of the ground bus 300 and subsets of the cables 104. FIG. 8 shows the third outer bus member 306 connected to the inner bus member 304 covering the third row of the cables 104.

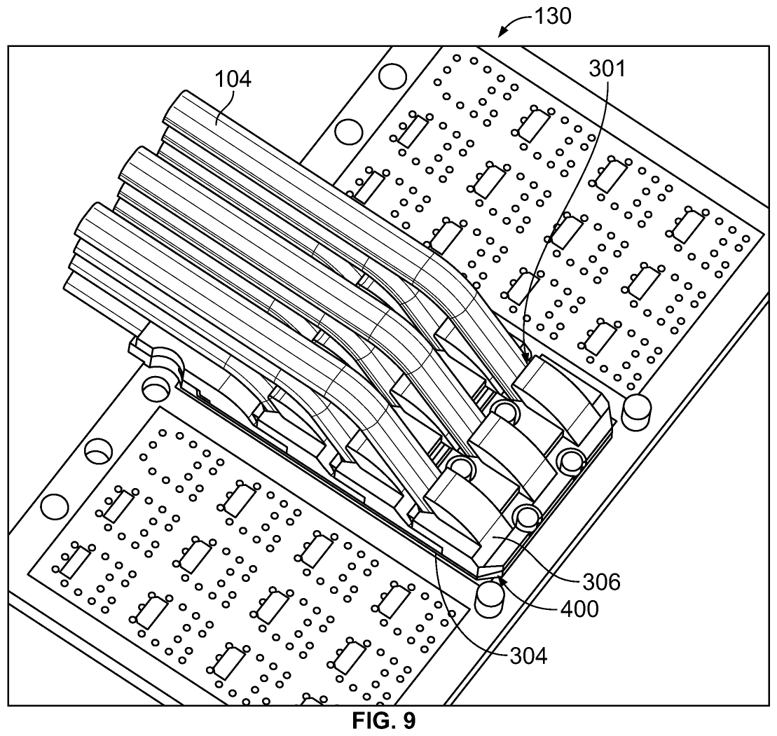

FIG. 9 is a top perspective view of a portion of the cable card assembly 130 in accordance with an exemplary embodiment. FIG. 9 shows four rows of the cables 104 and four of the outer bus members 306 connected to the inner bus member 304. All of the pockets 301 are surrounded and shielded by the inner and outer bus members 304, 306 and the conductive gasket 400 at the interface between the inner and outer bus members 304, 306.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A cable card assembly for an electrical connector comprising:
a circuit card having an array of circuit conductors on a surface of the circuit card, the circuit card having a ground plane;
cables terminated to the circuit card, the cables including signal conductors and cable shields surrounding the corresponding signal conductors to provide electrical shielding for the signal conductors, the signal conductors being electrically connected to corresponding circuit conductors of the circuit card; and
a ground bus coupled to the circuit card, the ground bus being electrically connected to the cable shields of the cables, the ground bus being electrically connected to the ground plane of the circuit card, the ground bus including a shell forming pockets receiving the corresponding cables, the shell having an inner bus member and an outer bus member coupled to the inner bus member, the inner bus member being mounted to the circuit card, the shell including a conductive gasket between the inner bus member and the outer bus member.

2. The cable card assembly of claim 1, wherein the conductive gasket is formed in place on at least one of the inner bus member and the outer bus member.

3. The cable card assembly of claim 1, wherein the conductive gasket is a room vulcanization temperature (RVT) material.

4. The cable card assembly of claim 1, wherein the conductive gasket is fixed to at least one of the inner bus member and the outer bus member at a temperature lower than a solder temperature.

5. The cable card assembly of claim 1, wherein the conductive gasket is applied to at least one of the inner bus member and the outer bus member in a dispersed pattern across the interface between the inner bus member in the outer bus member.

6. The cable card assembly of claim 1, wherein the conductive gasket is discontinuous at the interface between the inner bus member and the outer bus member.

7. The cable card assembly of claim 1, wherein the conductive gasket extends around each pocket.

8. The cable card assembly of claim 1, wherein each cable includes a drain wire, the drain wire be electrically connected to the conductive gasket.

9. The cable card assembly of claim 1, wherein the conductive gasket is arranged in dots dispersed around each pocket.

10. The cable card assembly of claim 1, wherein the shell includes a plurality of the outer bus members coupled to the inner bus member.

11. The cable card assembly of claim 10, wherein the conductive gasket is positioned between the outer bus members to connect the outer bus members to each other.

12. The cable card assembly of claim 1, wherein the inner bus member includes an inner locating element at the interface and the outer bus member includes an outer locating element at the interface, the outer locating element interacting with the inner locating element to locate the outer bus member relative to the inner bus member.

13. The cable card assembly of claim 12, wherein the conductive gasket is located at the interface between the outer locating element and the inner locating element.

14. A ground bus for electrically connecting cables to a circuit card of a cable card assembly, the ground bus comprising:
a shell including an inner bus member and an outer bus member separate and discrete from the inner bus member and coupled to the inner bus member at an interface, the inner bus member including a bottom configured to be mounted to the circuit card, the inner bus member including inner pockets, the inner bus member configured to be positioned between the cables and the circuit card, the outer bus member including covers configured to cover the cables, the covers forming outer pockets cooperating with the inner pockets to receive the corresponding cables, the inner bus member being electrically conductive and providing shielding around portions of the cables, the outer bus member being electrically conductive and providing shielding around portions of the cables;
a conductive gasket between the inner bus member and the outer bus member, the conductive gasket being electrically connected to the inner bus member and being electrically connected to the outer bus member to provide shielding at the interface.

15. The ground bus of 14, wherein the conductive gasket is formed in place on at least one of the inner bus member and the outer bus member.

16. The ground bus of 14, wherein the conductive gasket extends around each pocket.

17. The ground bus of 14, wherein the shell includes a plurality of the outer bus members coupled to the inner bus member, the conductive gasket being positioned between the outer bus members to connect the outer bus members to each other.

18. The ground bus of 14, wherein the inner bus member includes an inner locating element at the interface and the outer bus member includes an outer locating element at the interface, the outer locating element interacting with the inner locating element to locate the outer bus member relative to the inner bus member, the conductive gasket being located at the interface between the outer locating element and the inner locating element.

19. An electrical connector comprising:
a housing having walls forming a cavity, the housing having a mating end configured to be mated with a second electrical connector; and
a cable card assembly received in the cavity of the housing, the cable card assembly including a circuit card, cables terminated to the circuit card, and a ground bus coupled to the circuit card to provide shielding for the cables, the circuit card having an array of circuit conductors on a surface of the circuit card, the circuit card having a ground plane, the cables including signal conductors and cable shields surrounding the corresponding signal conductors to provide electrical shielding for the signal conductors, the signal conductors being electrically connected to corresponding circuit conductors of the circuit card, the ground bus being electrically connected to the cable shields of the cables, the ground bus being electrically connected to the ground plane of the circuit card, the ground bus including a shell forming pockets receiving the corresponding cables, the shell having an inner bus member and an outer bus member coupled to the inner bus member, the shell including a conductive gasket between the inner bus member and the outer bus member.

20. The electrical connector of claim 19, wherein the conductive gasket is formed in place on at least one of the inner bus member and the outer bus member.
